(19) United States
(12) Patent Application Publication
(10) Pub. No.: US 2019/0372435 A1
(43) Pub. Date: Dec. 5, 2019

(54) TEMPERATURE SENSOR BRACKET AND MOTOR COMPRISING THE SAME

(71) Applicant: MANDO CORPORATION, Gyeonggi-do (KR)

(72) Inventor: Baik Kee SONG, Gyeonggi-do (KR)

(21) Appl. No.: 16/426,976

(22) Filed: May 30, 2019

(30) Foreign Application Priority Data
May 31, 2018 (KR) 10-2018-0062610

(51) Int. Cl. H02K 11/25; G01K 7/22

(52) U.S. Cl. CPC H02K 11/25; B62D 63/04; G01K 7/22

(57) ABSTRACT

A temperature sensor bracket and a motor including the same are disclosed. The motor according to an embodiment of the present disclosure includes: a stator on which a coil is wound; an insulator configured to at least partially cover the stator; a temperature sensor bracket fixed to the insulator; and a temperature sensor fixed by the temperature sensor bracket to measure a temperature of the coil.

### CROSS-REFERENCE TO RELATED APPLICATION

This application claims priority to and the benefit of Korean Patent Application No. 10-2018-0062610, filed on May 31, 2018, the disclosure of which is incorporated herein by reference in its entirety.

### BACKGROUND

### 1. Field of the Invention

The present disclosure relates to a temperature sensor bracket and a motor including the same, and more specifically, to a temperature sensor bracket for holding a temperature sensor configured to measure a temperature of a coil in a motor and a motor including the same.

### 2. Discussion of Related Art

A motor can be used in an apparatus such as a brake of a vehicle or the like. When a harsh operation is performed or surrounding environment is severe while a vehicle is driven, the temperature of a coil in a motor increases, and thus the motor can be damaged. Accordingly, monitoring of the coil temperature in the motor and an appropriate response according to above are important.

Conventionally, a method of indirectly measuring the temperature of the coil in the motor instead of directly measuring the temperature of the coil in the motor is mainly used due to the restriction of a package. However, since an indirect assumption value is different from an actual temperature of the coil in the motor, the coil temperature of the motor is not easy to be correctly monitored.

More specifically, a method of restricting currents of a motor using a temperature sensor of a conventional electronic control unit (ECU) to prevent an excessive temperature increase of the coil in the motor exists, but the temperature of the coil in the motor is difficult to be assumed in a transient condition due to a thermal capacitance difference between the temperatures of the ECU and the motor coil. Further, when an operation of the motor is shut down by assuming the coil temperature in the ECU, since a function of a vehicle can have a problem in an emergency situation, the motor can be maximally operated within the scope in which the coil temperature does not increase.

When the above is considered, a method of optimally managing the coil temperature of the motor is directly measuring the temperature of the coil by attaching a temperature sensor in the motor. For this end, a temperature sensor bracket for holding the temperature sensor, configured to measure the coil temperature, in the motor is necessary. Accordingly, development of a temperature sensor bracket configured to allow installation of a temperature sensor in a motor within the scope in which a package of the motor is not largely influenced and a motor including the same has been required.

### SUMMARY OF THE INVENTION

The present disclosure is directed to a temperature sensor bracket for holding a temperature sensor configured to measure a coil temperature in a motor and a motor capable of directly measuring the coil temperature through the temperature sensor bracket.

Also, the present disclosure is directed to a temperature sensor bracket fixed to an insulator coupled to a stator of a motor and configured to stably hold a temperature sensor through a rotation prevention structure and a motor including the same.

Also, the present disclosure is directed to a temperature sensor bracket easily installable in a conventional motor package and a motor including the same.

According to an aspect of the present disclosure, there is provided a motor including: a stator on which a coil is wound; an insulator configured to at least partially cover the stator; a temperature sensor bracket fixed to the insulator; and a temperature sensor fixed by the temperature sensor bracket to measure a temperature of the coil.

In this case, the temperature sensor bracket may include a fixing part fixed to a fixing hole formed in the insulator; a supporting part having one side connected to the fixing part and the other side formed adjacent to the coil; and a holder connected to the other side of the supporting part to hold the temperature sensor.

Further, the stator may include a body forming a cylindrical shape and at least one tooth configured to protrude in an inner circumferential direction from an inner circumferential surface of the body to wound a coil, the insulator may include a body cover configured to at least partially cover the body and a tooth cover configured to at least partially cover the tooth, and the fixing hole may be formed in the body cover.

In addition, the insulator may include a plurality of divided insulators each including the body cover and the tooth cover.

In addition, the fixing hole may be formed by the body cover of the adjacent divided insulator.

In addition, the body cover of the adjacent divided insulator may additionally form a slit configured to communicate with the fixing hole in an inner circumferential direction.

In addition, a predetermined period of one end portion of the supporting part may be inserted into the slit to prevent rotation of the fixing part.

In addition, a lead line of the temperature sensor may be connected through a bus-bar.

According to another aspect of the present disclosure, there is provided a temperature sensor bracket including: a fixing part formed as a length member; a supporting part having one side connected to the fixing part and configured to extend toward the other side; and a holder connected to the other side of the supporting part to hold a temperature sensor.

In this case, the fixing part may be coupled to a fixing hole formed in an insulator coupled to a stator of a motor, and may have a length equal to or smaller than a depth of the fixing hole.

Further, the fixing part may include a protruding part formed to protrude toward an outer surface in a longitudinal direction.

In addition, the supporting part may be formed to be bent with directionality.

In addition, the supporting part may include an elastic material.

In addition, the supporting part may be formed by integrally molding plastic on an outer surface of a metal plate spring.

In addition, the holder may be formed to partially surround the temperature sensor.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view illustrating a motor according to an embodiment of the present disclosure;

FIG. 2 is a plan view of the motor according to the embodiment of the present disclosure;

FIG. 3 is an exploded perspective view of the motor according to the embodiment of the present disclosure;

FIG. 4 is a perspective view of a temperature sensor bracket according to the embodiment of the present disclosure;

FIG. 5 is a perspective view illustrating a state in which a temperature sensor is held on the temperature sensor bracket according to the embodiment of the present disclosure; and

FIG. 6 is a perspective view of divided insulators shown in FIGS. 1 to 3.

### DETAILED DESCRIPTION OF EXEMPLARY EMBODIMENTS

Hereinafter, exemplary embodiments of the present disclosure will be described in detail with reference to the accompanying drawings which may allow one of ordinary skill in the art to easily perform the present disclosure. The present disclosure may be implemented in various forms and is not limited to the following embodiments. Components not related to the description are not included in the drawings to clearly describe the present disclosure, and the same reference symbols are used for the same or similar components in the description.

It should be further understood that the terms “include,” “including,” “provide,” “providing,” “have,” and/or “having” specify the presence of stated features, integers, steps, operations, elements, components, and/or groups thereof but do not preclude the presence or addition of one or more other features, integers, steps, operations, elements, components, and/or groups thereof.

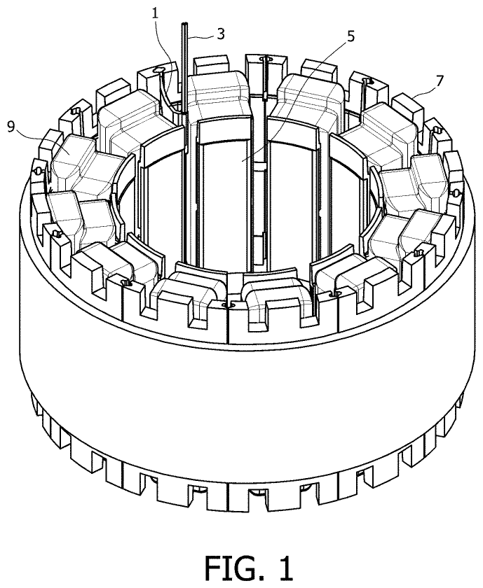

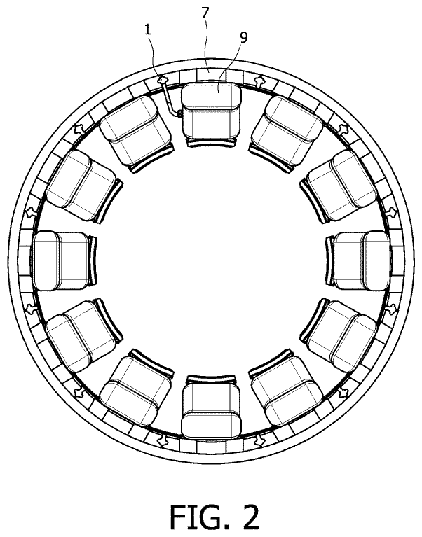

Referring to FIGS. 1 to 3, a motor according to an embodiment of the present disclosure provides a temperature sensor installation structure, capable of directly measuring a temperature of a coil 9 in the motor using a temperature sensor 3, through a temperature sensor bracket 1. In other words, the motor according to the embodiment of the present disclosure may allow the temperature of the coil 9 wound in the motor to be directly measured through the temperature sensor 3.

The motor according to the embodiment of the present disclosure includes the temperature sensor bracket 1, the temperature sensor 3, a stator 5, and an insulator 7.

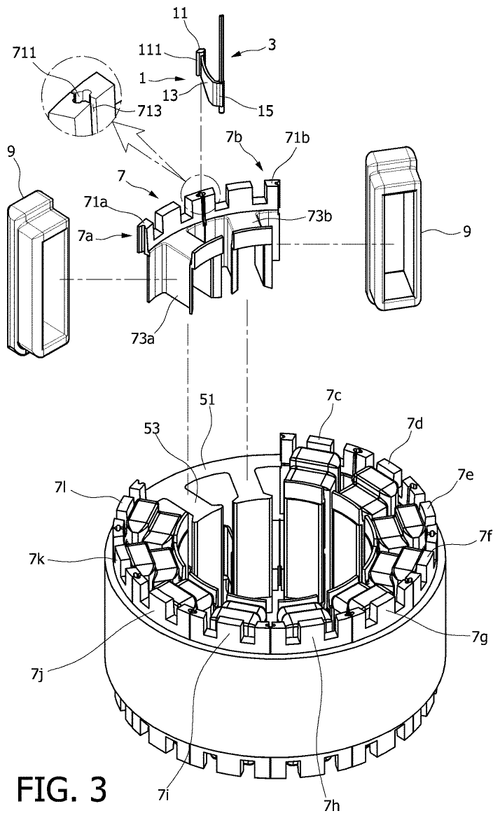

Referring to FIGS. 3 to 5, the temperature sensor bracket 1 fixes the temperature sensor 3 configured to measure the temperature of the coil 9 in the motor. In an embodiment of the present disclosure, the temperature sensor bracket 1 includes a fixing part 11, a supporting part 13, and a holder 15.

The fixing part 11 is formed as a length member. The fixing part 11 is a part fixed in the motor. In the embodiment of the present disclosure, the fixing part 11 may be fixed to the insulator 7 coupled to the stator 5 of the motor. In more detail, the fixing part 11 may be inserted into and fixed to a fixing hole 711 formed in the insulator 7. In this case, the fixing part 11 may have a length equal to or smaller than a depth of the fixing hole 711 formed in the insulator 7.

As shown in FIG. 3, in the embodiment of the present disclosure, the insulator 7 includes a plurality of divided insulators 7a, 7b, 7c, 7d, 7e, 7f, 7g, 7h, 7i, 7j, 7k, and 7l. In this case, the fixing hole 711 into which the fixing part 11 is inserted may be formed by a pair of divided insulators 7a and 7b which are adjacent to each other. In more detail, the fixing hole 711 may be formed by body covers 71a and 71b of the pair of divided insulators 7a and 7b configured to cover a body 51 of the stator 5 and disposed adjacent to each other.

Further, the fixing part 11 may include a protruding part 111 formed to protrude toward an outer surface in a longitudinal direction. Specifically, in the embodiment of the present disclosure, the fixing part 11 is formed in a cylinder shape, and includes the protruding part 111 formed in a radial direction along the longitudinal direction.

As described above, in the embodiment of the present disclosure, the fixing part 11 is inserted into and fixed to the fixing hole 711. In this case, when the fixing hole 711 is complementarily formed in the shape of the fixing part 11 including the protruding part 111, the protruding part 111 efficiently prevents rotation of the fixing part 11 in the fixing hole 711. Accordingly, the temperature sensor bracket 1 may stably maintain a position in the motor.

Meanwhile, unlike the embodiment of the present disclosure, the fixing part 11 may have a recessed part instead of the protruding part 111, and the fixing hole 711 may include a protruding part corresponding to the recessed part. The rotation of the fixing part 11 inserted into the fixing hole 711 may also be prevented through the above-described configuration.

The supporting part 13 is formed to have one side connected to the fixing part 11 and extends toward the other side. In the embodiment of the present disclosure, in the supporting part 13, the one side is connected to the fixing part 11, and the other side is connected to the holder 15. More specifically, in a state in which the temperature sensor bracket 1 is fixed in the motor, the one side of the supporting part 13 is connected to the fixing part 11 and the other side of the supporting part 13 is connected to the holder 15, and the other side of the supporting part 13 is formed to be adjacent to the coil 9 in the motor which is an object of which a temperature is measured. That is, the supporting part 13 has a shape of extending from the fixing part 11 to support the holder 15 adjacent to the coil 9.

In the embodiment of the present disclosure, the supporting part 13 may be formed to be bent with directivity. Specifically, the supporting part 13 may be formed to be bent with directionality so that the holder 15 is disposed adjacent to the coil 9 in a state in which the fixing part 11 is fixed. In other words, the supporting part 13 may have a shape bent toward the coil 9 to dispose the holder 15 adjacent to the coil 9 which is an object of which the temperature is measured.

Further, in the embodiment of the present disclosure, a predetermined period of one end portion of the supporting part 13 may be inserted into a slit 713 formed to communicate with the fixing hole 711 in the insulator 7 to prevent the rotation of the fixing part 11.

As shown in FIG. 3, the body covers 71a and 71b of the pair of divided insulators 7a and 7b which are adjacent to each other may additionally form the slit 713 configured to communicate with the fixing hole 711 in an inner circumferential direction. In this case, the predetermined period of one end portion of the supporting part 13 is inserted into and disposed in the slit 713 to prevent rotation of the fixing part 11 together with the protruding part 111 formed on the fixing part 11 or prevent rotation of the fixing part 11 instead of the protruding part 111 when the protruding part 111 does not exists.

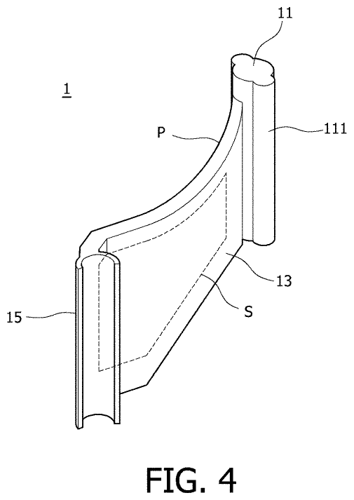

According to the embodiment of the present disclosure, the supporting part 13 may include an elastic material. The supporting part 13 may press the holder 15 toward the coil 9 so that the temperature sensor 3 held on the holder 15 may come into close contact with the coil 9. In order to implement the above-described structure, the supporting part 13 may include an elastic material. Referring to FIG. 4, in the embodiment of the present disclosure, the supporting part 13 may be formed by integrally molding plastic P on an outer surface of a metal plate spring S.

In the embodiment of the present disclosure, the temperature sensor bracket 1 may be integrally molded. For example, a method of integrally molding the entire temperature sensor bracket 1 for measuring the coil temperature, including the supporting part 13, through insert injection-molding to in a state in which the metal plate spring S is disposed in an injected mold may be considered.

The holder 15 is connected to the other side of the supporting part 13 to hold the temperature sensor 3. As described above, the holder 15 may be integrally formed with the supporting part 13, and a specific shape thereof may be varied according to the type and shape of the temperature sensor 3.

In this case, the holder 15 may be formed to partially surround a sensing part 31 of the temperature sensor 3 so that the sensing part 31 of the temperature sensor 3 may be at least partially exposed to the coil 9.

The holder 15 may be formed in a shape partially surrounding an outer circumferential surface of the sensing part 31 when the sensing part 31 is formed as a cylindrical-shaped tube. Further, the holder 15 may provide a structure to which the sensing part 31 is fitted and fixed.

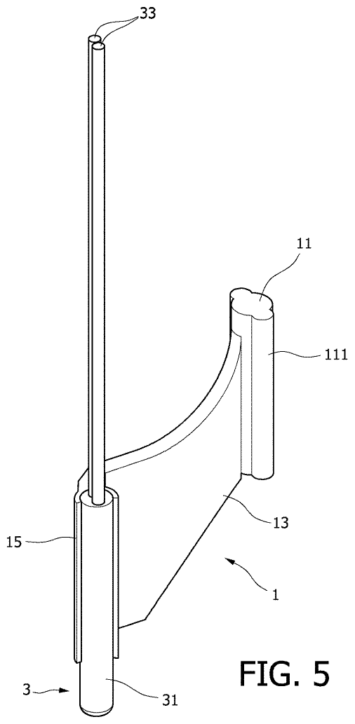

The temperature sensor 3 is fixed by the temperature sensor bracket 1 to measure the temperature of the coil 9. Referring to FIG. 5, in the embodiment of the present disclosure, the temperature sensor 3 may be a thermistor. More specifically, the temperature sensor 3 may be formed of a negative temperature coefficient (NTC) thermistor.

As described above, when the thermistor is used as the temperature sensor 3, the temperature sensor 3 may include the sensing part 31 configured to sense the temperature, and a lead line 33 withdrawn from the sensing part 31 and connected to external positive and negative terminals.

The stator 5 is a member on which the coil 9 forming a rotating magnetic field is wound. The stator 5 is fixed in a housing (not shown) of the motor to generate rotation movement together with a rotor disposed on an inner circumferential surface of a hollow hole by electromagnetic interaction.

In the embodiment of the present disclosure, the stator 5 may include the body 51 forming a cylindrical shape, and at least one tooth 53 configured to protrude in an inner circumferential direction from an inner circumferential surface of the body 51 to wound the coil 9.

In this case, the tooth 53 may protrude to be radially spaced apart from each other at a predetermined interval along the inner circumferential surface of the body 51. The coil 9 is wound on the tooth 53.

Meanwhile, bus-bars electrically connected to the coils 9 may be disposed on the stator 5. In general, in a motor used in a vehicle, a plurality of coils are usually connected in parallel to reduce loss due to coil resistance, and a method of extending the coils to input/output terminals and collectively connecting at the terminals is used in parallel connection. The bus-bars may be disposed on the upper part of the stators 5 to collectively connect the coils 9 which are disposed in parallel.

The insulator 7 is a member configured to at least partially cover the stator 5 to insulate the stator 5. In the embodiment of the present disclosure, the insulator 7 is coupled to the stator 5 to entirely insulate the stator 5.

In the embodiment of the present disclosure, the insulator 7 includes the plurality of divided insulators 7a, 7b, 7c, 7d, 7e, 7f, 7g, 7h, 7i, 7j, 7k, and 7l. When the stators 5 are formed to include the teeth 53 radially formed to be uniform with the cylindrical-shaped body 51, each of the divided insulators 7a, 7b, 7c, 7d, 7e, 7f, 7g, 7h, 7i, 7j, 7k, and 7l uniformly covers a portion of the stator 5, and may be coupled to the stator 5. Each of the divided insulators 7a, 7b, 7c, 7d, 7e, 7f, 7g, 7h, 7i, 7j, 7k, and 7l may be formed in the same shape.

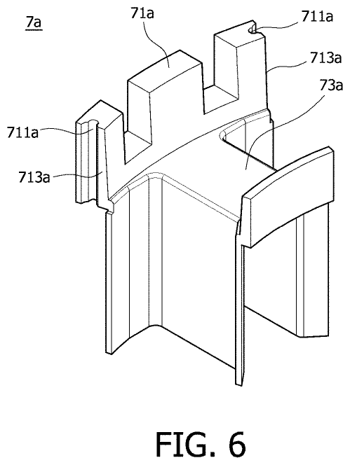

Referring to FIGS. 3 and 6, the pair of divided insulators 7a and 7b disposed adjacent to each other may include the body covers 71a and 71b configured to at least partially cover the body 51 of the stator 5, respectively, and tooth covers 73a and 73b configured to at least partially cover the tooth 53, respectively.

The body covers 71a and 71b are parts configured to cover the body part 51 of the stator 5, and have the same curvature as that of the body part 51, and at least partially cover an upper surface of the body part 51.

In the embodiment of the present disclosure, the body covers 71a and 71b of the pair of divided insulators 7a and 7b, which are adjacent to each other, form the fixing hole 711 in a state of being disposed adjacent to each other. In more detail, a recessed part 711a forming a half of the fixing hole 711 is formed on a side surface of the body cover 71a of the divided insulator 7a and an adjacent recessed part of the divided insulator 7b is symmetrically disposed parallel to the recessed part 711a, and thus one fixing hole 711 is formed.

As described above, the fixing part 11 of the temperature sensor bracket 1 is inserted into and fixed to the fixing hole 711. For this end, the fixing hole 711 may have a shape complementary to the fixing part 11. In addition, the depth of the fixing hole 711 may be formed to be equal to or greater than the length of the fixing part 11 of the temperature sensor bracket 1.

Further, in the embodiment of the present disclosure, the body covers 71a and 71b of the pair of divided insulators 7a and 7b which are adjacent to each other may additionally form the slit 713 configured to communicate with the fixing hole 711 in the inner circumferential direction. Specifically, a recessed part 713a forming a half of the slit 713 is formed in a side surface of the a body cover 71 of the divided insulator 7a, and an adjacent recessed part of the divided insulator 7b may be symmetrically disposed parallel to the recessed part 713a to form one slit 713.

The supporting part 13 of the temperature sensor bracket 1 is partially inserted into and disposed in the slit 713. Accordingly, the shape, width, or the like of the slit 713 may be formed to correspond to a portion of the supporting part 13 inserted into the slit 713.

Meanwhile, in the embodiment of the present disclosure, the plurality of divided insulators 7a, 7b, 7c, 7d, 7e, 7f, 7g, 7h, 7i, 7j, 7k, and 7l may form the fixing hole 711 and the slit 713 in each of adjacent portions through the above-described configuration. Accordingly, in the case of the embodiment of the present disclosure, an installation position of the temperature sensor bracket 1 in the motor may be variously selected. Further, a plurality of temperature sensor brackets 1 may be installed in the motor as necessary.

According to embodiments of the present disclosure, since a temperature sensor can be installed in a motor through a temperature sensor bracket installed in the motor, monitoring and managing the temperature of a coil in the motor can be efficiently performed.

According to the embodiments of the present disclosure, the temperature sensor configured to measure the temperature of the coil can be efficiently and stably held in the motor through a coupling structure between an insulator and the temperature sensor bracket.

Although one embodiment of the present disclosure is described above, the spirit of the present disclosure is not limited by the embodiment shown in the description, and although those skilled in the art may provide other embodiments through the addition, change, or removal of the components within the scope of the same spirit of the present disclosure, such embodiments are also included in the scope of the spirit of the present disclosure.

What is claimed is:

1. A motor comprising:
a stator on which a coil is wound;
an insulator configured to at least partially cover the stator;
a temperature sensor bracket fixed to the insulator; and
a temperature sensor fixed by the temperature sensor bracket to measure a temperature of the coil.

2. The motor of claim 1, wherein the temperature sensor bracket includes: a fixing part fixed to a fixing hole formed in the insulator; a supporting part having one side connected to the fixing part and the other side formed adjacent to the coil; and a holder connected to the other side of the supporting part to hold the temperature sensor.

3. The motor of claim 2, wherein:
the stator includes a body forming a cylindrical shape and at least one tooth configured to protrude in an inner circumferential direction from an inner circumferential surface of the body to wound a coil;
the insulator includes a body cover configured to at least partially cover the body and a tooth cover configured to at least partially cover the tooth; and
the fixing hole is formed in the body cover.

4. The motor of claim 3, wherein the insulator includes a plurality of divided insulators each including the body cover and the tooth cover.

5. The motor of claim 4, wherein the fixing hole is formed by the body cover of the adjacent divided insulator.

6. The motor of claim 5, wherein the body cover of the adjacent divided insulator additionally forms a slit configured to communicate with the fixing hole in an inner circumferential direction.

7. The motor of claim 6, wherein a predetermined period of one end portion of the supporting part is inserted into the slit to prevent rotation of the fixing part.

8. The motor of claim 1, wherein a lead line of the temperature sensor is connected through a bus-bar.

9. A temperature sensor bracket comprising:
a fixing part formed as a length member;
a supporting part having one side connected to the fixing part and configured to extend toward the other side; and
a holder connected to the other side of the supporting part to hold a temperature sensor.

10. The temperature sensor bracket of claim 9, wherein the fixing part is coupled to a fixing hole formed in an insulator coupled to a stator of a motor, and has a length equal to or smaller than a depth of the fixing hole.11. The temperature sensor bracket of claim 9, wherein the fixing part includes a protruding part formed to protrude toward an outer surface in a longitudinal direction.

12. The temperature sensor bracket of claim 9, wherein the supporting part is formed to be bent with directionality.

13. The temperature sensor bracket of claim 9, wherein the supporting part includes an elastic material.

14. The temperature sensor bracket of claim 13, wherein the supporting part is formed by integrally molding plastic on an outer surface of a metal plate spring.

15. The temperature sensor bracket of claim 9, wherein the holder is formed to partially surround the temperature sensor.
